(19) United States
(12) Patent Application Publication
(10) Pub. No.: US 2008/0188783 A1
(43) Pub. Date: Aug. 7, 2008

(54) Self-actuating sequential & gradient compression apparatus

(76) Inventors: Jordy M. Wells, Beverly Hills, CA (US); T. Addison Wells, Beverly Hills, CA (US)

Correspondence Address: Jordy M. Wells, 439 S. Oakhurst Dr., Beverly Hills, CA, 90212, US

(21) Appl. No.: 11/701,625

(22) Filed: Feb. 2, 2007

(51) Int. Cl. A61H 9/00; F16K 47/00

(52) U.S. Cl. 601/152; 251/124

(57) ABSTRACT

The present invention proposes an improved method and apparatus for the prevention and treatment of lymphatic and other type edemas with a Self-Actuating Sequential and Gradient Compression Apparatus comprised of a multiplicity of inflatable cells each cell in series, but the last connected to the next by a plurality of one-way valves which vent in such a regulated way as to control the pressure, velocity, or volume of air or other fluid flowing through one cell to another fully inflating the first cell before the subsequent cell for gradient pressure effect. In this manner unidirectional sequential and gradient waveforms are generated. The last cell in series, alone, finally vents the overall increase in pressure back to the first cell thus completing a circuit and allowing pressure equilibrium to be reestablished throughout the system. Resulting massaging waveforms generated by the normal flexing of muscles within the confines of the encircling inflatable cells during everyday activities such as housekeeping, childrearing, and work serve to augment blood circulation and initiate, compel, and conduct the flow of lymphatic and other toxins from affected upper or lower extremities, chest, shoulder, stomach, or buttocks in the direction of the torso or otherwise to where such waste materials may be absorbed and eliminated by healthy, active lymphnodes or to where other normal bodily functions may accomplish the same result. In the absence of such aforementioned ailments or injuries the massaging waveforms generated by the proposed Self-Actuating Sequential and Gradient Compression Apparatus may be applied for their purely pleasurable, relaxation, and muscle toning benefit.

The present invention discloses a novel and improved method and apparatus for the prevention and treatment of lymphatic and other type edemas, with applications in sports medicine such as therapy for injured muscles or connective tissue and in cosmetic procedures such as in the prevention and treatment of cellulite, or for purely hedonistic purposes, with a Self-Actuating Sequential and Gradient Compression Apparatus; and more particularly an apparatus comprised of a multiplicity of extremity or other body part enveloping inflatable cells connected in series by a plurality of one-way valves the entirety self-actuated in such sequence that when any individual cell is or group of cells are compressed by the flexing of enveloped muscles during everyday activities unidirectional massaging waveforms are generated which initiate, compel and conduct the flow of lymphatic and other toxins from an affected upper or lower extremity, chest, shoulder, stomach, buttocks to healthy and active lymphnodes or to other areas where such waste materials may be absorbed or otherwise eliminated by other normal and healthy bodily functions.

### BACKGROUND OF THE INVENTION

Lymphedema is a debilitating progressive condition with no known cure. The patient faces a lifelong struggle with medical and surgical treatment often leading to gangrenous streptococcal infection resulting in amputation, and even cellulites resulting in death.

Lymphedema is the result of an abnormal accumulation of interstitial fluid containing high molecular weight proteins, the result of the absence of or failure in a lymphatic system.

An article published at eMedicine.com in October 2005, authored by Don R. Revis, Jr, MD, Consulting Staff, Department of Surgery, Division of Plastic and Reconstructive Surgery, University of Florida College, member of the American College of Surgeons, American Medical Association, American Society for Aesthetic Plastic Surgery, and American Society of Plastic Surgeons states that, worldwide, there are between 140-250 million reported cases of lymphedema.

Lymphatic filariasis is the most common form of the disease, the result of parasitic infestation most commonly found in Africa, India, Southeast Asia, the Pacific islands, the Caribbean, South America, and Southeast Asia.

Lymphedema is also caused by a genetic defect, resulting in Primary Lymphedema, a consequence of surgery or radiation treatment for breast and testicular cancers, called Secondary Lymphedema, or the result of surgery on blood vessels in the limbs, liposuction, and the consequence of burns.

Millions more are afflicted with similar or related ailments such as venous disorders, ulcers, and diabetic limbs. All may benefit, to greater of lesser degree, from the massaging waveforms created by the Self-Actuated Sequential and Gradient Compression Apparatus.

In most of the world funding for the purchase, training, and application of complex and expensive extant lymphedema treatment devices is sorely lacking. As many millions are put at risk of amputation of a limb, often within four years of the onset of lymphedema, and even the possibility of death within as few as ten years.

Manual Lymph Drainage (MLD) and Elevation are the two most common noninvasive forms of treatment for lymphedema. MLD must be performed by a qualified lymphedema therapist and can cost as much as $200 per session and initially require as many as three sessions per week. In any event MLD is often just the first step in dealing with the ailment.

The use of compression is also an important factor is maximizing gains between medical visits or MLD sessions. The two basic types of compression are:

Mechanical Compression is most often gradient, varying in degree of compression by elasticity of materials or taught-ness of straps. Such devices must usually be tailored to individual patients and can cost from hundreds of dollars to well over $1,000. Many such devices are bulky, cumbersome, visually unattractive, and physically and psychologically uncomfortable to wear. More importantly, they are only marginally effective.

Results are better with pneumatic systems that produce rolling compressive waveforms, but these often cost $5,000 to $10,000 or more. Many are leased which, over time, actually increases the amount paid. These complex devices are also extremely uncomfortable due to erratic noise and high pressures, and confining as one is usually required to be seated or prone while attached to the sleeve, connective tubing, computerized sequencer, and mechanical compressor of some sort. Thus, such systems often fall into disuse and eventually discarded altogether.

Exemplars of extant compression devices, of both types, for the treatment of lymphedema and like ailments include U.S. Pat. Nos. 5,125,400 Johnson, Jr. June 1992; 5,179,941 Siems et al. January 1993; RE 34661 Grim July 1994; 5,328,445 Spahn et al. July 1994; 5,437,610 Vikram et al. August 1995; 5,443,440 Tumey et al. August 1995; 5,450,858 Zablotsky et al. September 1995; 5,575,762 Peeler et al. November 1996; 5,591,200 Cone et al. January 1997; 5,626,556 Tobler et al. May 1997; 6,656,141 Reid September 1998; 5,916,183 Reid June 1999; and 6,315,745 Kloecker November 2001. Most of these, unfortunately, suffer from one or more of the abovementioned shortcomings, and all fail to address the very special needs of many end users, because they do not take into consideration the unique environments and lack of social and medical infrastructure in the varied countries and regions where the great majority of those affected by lymphedema reside.

Lymphedema is a pernicious ailment and, even with maximum reversal of the deleterious medical and cosmetic effects of the ailment, prophylactic treatment must continue for life. Without such intervention any curative effect will inexorably be reversed by the same lymphatic failure that initially caused the condition. Subsequently, the patient risks further disfigurement, fibrosis, gangrene, amputation of the affected limb, and even death.

The primary problem with lymphedema is that it is essentially medically untreatable. While various symptoms should certainly be addressed by a physician, the root cause of lymphedema, at least, is the absence or failure of healthy, active lymphnodes, a filtering system within the body forming clusters in the underarms, groin, neck, chest, and abdomen.

In such absence of lymphatic functions a mechanical device (much as a mechanical heart replaces a failed one) innovative engineering holds out the best hope. The Self-Actuating Sequential and Gradient Compression Apparatus is such a device, intended to prove preventative, curative, AND prophylactic.

Additionally, the Self-Actuating Sequential and Gradient Compression Apparatus may be applied in sports medicine such as in therapy for injured muscles or connective tissue, and in cosmetic procedures such as in the prevention and treatment of cellulite, or its massaging waveforms utilized for purely hedonistic purposes.

### SUMMARY OF THE INVENTION

The Self-Actuated Sequential and Gradient Compression Apparatus proposed by this invention addresses lymphatic and traumatic edemas, venous disorders, ulcers, diabetic limbs, cosmetic enhancement procedures such as the treatment of cellulite, and sports medicine such as the relieving of muscle fatigue or injury. It is safe, dependable, adaptable, easy to apply and use, unobtrusive, minimally restrictive, optimally effective, and actuated by everyday activities such as housekeeping, childrearing, and ordinary or even exacting labor.

To further clarify the novel and most important aspects of the proposed invention: the clenching of the hand, flexing of the fore or upper arm, shoulder, chest, stomach, or thigh muscles, or the fulcrum effect of bending or rotating the wrist, elbow, knee, or ankle all serve to increase compressive load on encircling inflatable cell(s) juxtaposed to such muscle activity by up to 100%. Collectively, because of the interconnection of one inflatable cell to another by one-way valves in series, unidirectional sequential and gradient massaging waveforms are created that initiate, compel and conduct toxins and other waste materials and fluids to healthy lymphnodes or to where they can be eliminated by other normal bodily functions.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an upper torso with crossed arms, each covered by an apparatus consisting of a series of five (exemplar) inflatable cells 10, 11, 12, 13, and 14 connected in series by one-way valves 15. The right arm being covered over by the left arm, the one-way valve connecting inflatable cells 11 and 12 on the right arm is hidden beneath the left forearm, as is the intersection between inflatable cells 11 and 12. In any case, the last inflatable in a series vents back to the first in order to reestablish pressure equilibrium throughout the system.

An oral inflation or initial charging, pressure maintenance, emergency venting, and deflation-when-not-in-use component, consisting of a one-way valve and stem 16 (extended on the right sleeve and folded down, out of the way on the left arm) intersecting the air or other fluid return tube 18 which connects the last inflatable cell in the series 14 with the first inflatable cell in the series 10, here seen extending downward on the outside of the arm from the open left hand near the bottom of the last inflatable cell 14. Other devices such as pressure gauges and the like may be incorporated into this element of the apparatus or elsewhere. Once the system is charged the inflation component is slipped into a containment pocket or folded and held in place along the axis of the apparatus by a concealing flap closeable by Velcro or other type of mechanical or adhesive means.

Openings or “bend ports” 17 at the crux of the elbow and back of the wrist, and at the back of the knee in the leg configuration, aid the free movement of the affected limb in allowing the self-actuated compression capability necessary for creating the massage waveform.

FIG. 2 is a side view of a venturi tube 20 which may be inserted into or otherwise incorporated in the design, manufactured or assembly of a one-way valve such as a duck-bill (exemplar) one-way valve 21.

By varying the orifice (Pb) diameter of venturis or using other variable symmetry in the design, manufacture, or assembly of one way-valves, decreasing air or other fluid flow in the most beneficial direction or by modifying the spring load of closure in a one-way pressure, velocity, or volume of air or other fluid being compressed by the flexing of muscles confined within inflatable cells may be regulated. This sequential diminishment creates declining gradient pressure in each subsequent inflatable cell in s sequence or series.

For purposes of clarity and brevity, like elements and components will bear the same designations and numbering throughout the figures.

### DESCRIPTION OF THE PREFERRED EMBODIMENT

Referring now to the basic configuration of the proposed compressive device:

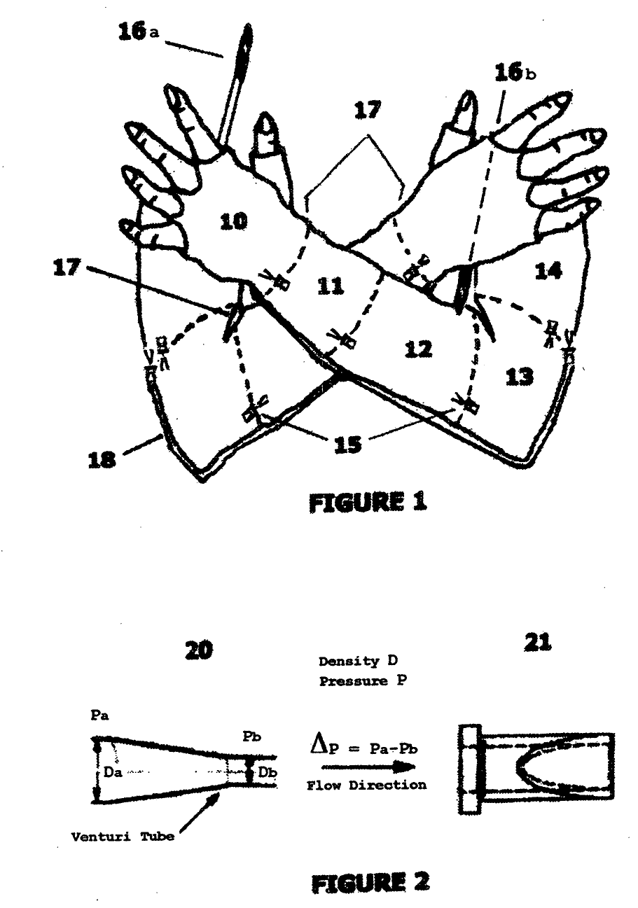

The invention's left and right crossed-arms configuration FIG. 1 includes a contoured, loosely fitted extremity apparatus containing a multiplicity of extremity encircling inflatable cells 10, 11, 12, 13, and 14 circumferentially and axially butted together to assure that body fluids do not pool between. Connected in series by a plurality of one-way valves 15, the cells when compressed singularly or in combination by the flexing of muscles confined within the encircling containing inflatable cells during normal daily activity generate a massaging waveform which initiates, compels and conducts fluids contained within the affected extremity or other body part to flow unidirectionally toward healthy and active lymphnodes or to where other normal and healthy bodily functions will dispose of them.

In the leg configuration, the first or foot cell (corresponding to the hand cell 10 in FIG. 1) is compressed by the full weight of the body on heal and sole when walking, and/or initiated and perpetuated by muscle flexing in the ankle, calf, thigh before being returned to the foot, after sequence completion, where static pressure equilibrium is finally restored.

The material construct of the apparatus containing the connected cells would ideally be of a breathable or vented non-elastic material, designed with easy access at one end of a tubular shape or open along all or segmented parts of its axis. In this latter configuration the apparatus should be closable by Velcro or other mechanical or adhesive means along any axial portion.

Additionally, openings or “bending ports” 17 at the inside of the wrist, elbow, armpit, and at the back of the knee in the lower extremity are provided to allow for full and normal use and motion of the affected limb.

Unlike many other designs, exact dimensions governed by the particular nature and girth of a patient's affected extremity may not necessarily require tailoring, as pressurization of the enveloping device usually adapts and conforms sufficiently to an extremity when inflated.

The Self-Actuating Compression Apparatus proposed herein is initially charged by an oral inflation tube, much like a life jacket. Variants on this charging system are foreseen and, even if only redundant, may include a sphygmomanometer bulb or other mechanical pump, or a pressurized cylinder of some sort. In such cases, however, in the interest of safety, an emergency relief valve and pressure gauge (redlined at 40-45 mmHg, for example) should be included in the circuit.

The first cell in an extremity configuration, at least, should be on the hand or foot side of the affected area, then connected to all others in series by one-way valves allowing air or other fluid contained within the system to flow axially only in the direction of the torso, except for the last which finally vents by one-way valve from the last cell directly back to the first cell, allowing pressure equilibrium to reestablish itself throughout the system. In the event the torso is involved an axis should be established which best compels the flow of unwanted fluids in the most advantageous direction to best dispose of them. In any event, inflatable cells should always be butted together to avoid toxins and waste fluids pooling between.

The overall pressure, velocity and volume of the fluid exchanged between inflatable cells, all affecting the waveform and overall massaging effect, can be predetermined by controlling the pressure, velocity, or volume of air or other fluid flowing through valve. Such regulation is important, because the rate of inflation of a leading cell must be greater than its exhaust rate in order to allow pressure to build up and maximize the gradient component of the massaging waveform.

Included in this patent proposal is a novel and unique insert-able venturi 20 (coupled in FIG. 2 with a duckbill one-way valve 21). In this exemplar, by decreasing the orifice diameter (Pb) of the valve insert 20 closer to the torso, the inflatable cell preceding that valve will completely pressurize before fully exhausting into the proceeding inflatable cell. Thus maximum gradient compression effect is achieved. However, this same function can be accomplished by varying the dimension of the same type of one-way valve, using different types of one-way valves in series, varying the load of closure on spring loaded one-way valves, or utilizing the physical properties of materials used in the manufacture one-way valves.

An oral initial inflation or charging, pressure maintenance, emergency venting or deflation, and deflation-when-not-in-use component, consisting of a one-way valve and stem 16 intersecting the air or other fluid return tube 18 which connects the last inflatable cell in the series 14 with the first inflatable cell in the series 10, here seen extending from the open left hand near the last inflatable cell 14. Other devices may be incorporated into this system, such as a pressure gauge and the like. Once the system is charged the inflation component is slipped into a containment pocket or folded and held in place along the axis of the apparatus by a concealing flap closeable by Velcro or other type of mechanical or adhesive means.

Testing has proved that oral inflation is an ideal system, because most people are incapable of reaching or exceeding the acceptably safe pressure range of about 35-40 mm Hg by simply blowing into a tube. Under self-actuating compression, however, this number necessarily increases, but only by a factor of 1.5 to 2.0 and only for a dwell of a few seconds. In any event, the proposed apparatus need only be inflated until it is comfortably snug to be optimally effective, while computerized, highly expensive and confining pneumatic systems, on the other hand, often exceed 100 mm Hg.

An important variant of the present invention is foreseen. For short term use, such as after surgery or radiation treatment for breast cancer, for example, to save life in emergency, or to make affordable in the third world an inexpensive, if less durable, perhaps “disposable” version would suffice.

A covering sleeve for this apparatus is also foreseen and should prove invaluable if they include high temperature and water resistance, and allow for heat exhaustion or “breath-ability.” Such materials may be configured for containment, concealment, comfort, or cosmetic presentation in a tubular shape (like a glove) or open along all or segmented parts closable by Velcro or other mechanical or adhesive means along any axial portions.

The preferred method of the present invention, however, relates to any or all of the preceding elements or processes applied to accomplish the same end. And since other modifications and changes to fit particular requirements and environments will be apparent to those skilled in the art, the invention is not considered limited to the example(s) chosen or shown for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A self-actuating compression apparatus wherein unidirectional massaging waveforms are formed and perpetuated sequentially by the flexing of muscles within its confines during normal activities such as housekeeping, childrearing, and work, comprising:
a multiplicity of circumferentially enveloping removable and/or detachably secured inflatable cells;
a plurality of one-way valves each connecting one inflatable cell to another in series within the apparatus, each cell being joined to the next to allow air or other fluid contained within the system to flow unidirectionally from one cell to another sequentially through the series, the last cell alone venting back to the first, thus reestablishing pressure equilibrium throughout the apparatus;
and a means to initially charge the system with air or other fluid for use, to maintain effective static pressure throughout, and for discharging the system for reasons of safety or when the apparatus is not in use.

2. A one-way valve that controls pressure, velocity, or volume of air or other fluid flowing through it for gradient or other effects, by means of:
the inclusion of a venturi or other device of variable symmetry incorporated in the design, manufacture, or assembly of said one way-valves.

3. A one-way valve that controls pressure, velocity, or volume of air or other fluid flowing through it for gradient or other effects, by means of:
varying the spring load of mechanical closure in the design, manufacture or assembly of said one-way valves.
